(19) United States
(12) Patent Application Publication
(10) Pub. No.: US 2020/0167698 A1
(43) Pub. Date: May 28, 2020

(54) PRE-REMINDER SYSTEM BY MOBILITY SERVICE

(71) Applicant: HONDA MOTOR CO., LTD., Tokyo (JP)

(72) Inventor: Kiyotaka KAWASHIMA, Los Angeles, CA (US)

(21) Appl. No.: 16/202,923

(22) Filed: Nov. 28, 2018

(51) Int. Cl. G06Q 10/02; G06Q 50/30; G06Q 10/10

(52) U.S. Cl. CPC G06Q 10/02; G06Q 10/1095; G06Q 50/30

(57) ABSTRACT

Systems and methods for providing mobility services may include a memory storing instructions and a processor coupled with the memory. The processor may be configured to execute the instructions to determine whether a user is being transported to a service provider. The processor may also be configured to transmit an indication to the service provider based on whether the user is being transported. The processor may further be configured to update a reservation time based on the indication.

### BACKGROUND

Users schedule appointments for visiting service providers. These appointments may include doctor, dentist, attorney, psychologist, or restaurants. Once an appointment is made, a service provider relies on a user to arrive in a timely manner for the reserved appointment time and to also check in after arrival at the location of the service provider. For many service providers, a user who does not arrive (i.e., no show) for the reserved appointment may be a significant issue. The service provider may spend a significant amount of time on determining whether the user is still going to arrive at a later time, or the service provider may spend additional time attempting to reallocate the reserved appointment time for another user. As a result of a no show, a service provider's time utilization may deteriorate, a service provider's quality for overall service may decline, and/or the cost of services may increase. Therefore, there remains an unmet need in the art for methods and systems for improving appointment scheduling services.

### SUMMARY

The following presents a summary of one or more aspects of the disclosure in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects of the disclosure in a simplified form as a prelude to the more detailed description that is presented later.

In an example, a system of a mobility service is provided. The system may include a memory storing instructions. The system may also include one or more processors coupled with the memory and configured to execute the instructions. The one or more processors may determine whether a user is being transported to a service provider. The one or more processors may also transmit an indication to the service provider based on whether the user is being transported. The one or more processors may further update a reservation time based on the indication.

In another example, a method for mobility service is provided. The method may include determining whether a user is being transported to a service provider. The method may also include transmitting an indication to the service provider based on whether the user is being transported. The method may further include updating a reservation time based on the indication.

In another example, a computer-readable medium storing executable code for mobility service is provided. The computer-readable medium may include code to determine whether a user is being transported to a service provider. The computer-readable medium may also include code to transmit an indication to the service provider based on whether the user is being transported. The computer-readable medium may further include code to update a reservation time based on the indication.

In another example, an apparatus for mobility service is provided. The apparatus may include means for determining whether a user is being transported to a service provider. The apparatus may also include means for transmitting an indication to the service provider based on whether the user is being transported. The apparatus may further include means for updating a reservation time based on the indication.

To the accomplishment of the foregoing and related ends, the one or more aspects of the disclosure comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The novel features believed to be characteristic of aspects described herein are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advances thereof, will be best understood by reference to the following detailed description of illustrative implementations when read in conjunction with the accompanying drawings.

FIG. 1 illustrates examples of conceptual views of interactions between a user and a service provider according to one aspect of the disclosure;

FIG. 2 illustrates a conceptual view of a mobility system according to one aspect of the disclosure;

FIG. 3 illustrates an example of a schematic view of a mobility communication system or a service provider according to one aspect of the disclosure;

FIG. 4 illustrates examples of a mobility service according to one aspect of the disclosure;

FIG. 5 illustrates an example of a flowchart of a method for providing mobility service according to one aspect of the disclosure;

FIG. 6 illustrates an example of a schematic view of a mobility vehicle according to one aspect of the disclosure; and

FIG. 7 illustrates an example system diagram of various hardware components and other features according to one aspect of the disclosure.

### DETAILED DESCRIPTION

The following includes definitions of selected terms employed herein. The definitions include various examples and/or forms of components that fall within the scope of a term and that may be used for implementation. The examples are not intended to be limiting.

The term “bus,” as used herein, may refer to an interconnected architecture that is operably connected to transfer data between computer components within a singular system or multiple systems. The bus may be a memory bus, a memory controller, a peripheral bus, an external bus, a crossbar switch, and/or a local bus, among others. The bus may also be a vehicle bus that interconnects components inside a vehicle using protocols such as Controller Area Network (CAN), Local Interconnect Network (LIN), among others.

The term “memory,” as used herein, may include volatile memory and/or nonvolatile memory. Non-volatile memory may include ROM (read only memory), PROM (programmable read only memory), EPROM (erasable PROM) and EEPROM (electrically erasable PROM). Volatile memory may include RAM (random access memory), synchronous RAM (SRAM), dynamic RAM (DRAM), synchronous DRAM (SDRAM), double data rate SDRAM (DDR SDRAM), and direct RAM bus RAM (DRRAM).

The term “operable connection,” as used herein, may include a connection by which entities are “operably connected”, is one in which signals, physical communications, and/or logical communications may be sent and/or received. An operable connection may include a physical interface, a data interface, and/or an electrical interface.

The term “processor,” as used herein, may refer to a device that processes signals and performs general computing and arithmetic functions. Signals processed by the processor may include digital signals, data signals, computer instructions, processor instructions, messages, a bit, a bit stream, or other computing that may be received, transmitted and/or detected. A processor may include microprocessors, microcontrollers, digital signal processors (DSPs), field programmable gate arrays (FPGAs), programmable logic devices (PLDs), state machines, gated logic, discrete hardware circuits, or other suitable hardware configured to perform the various functionality described herein.

The term “vehicle,” as used herein, may refer to any moving vehicle that is capable of carrying one or more human occupants and is powered by any form of energy. The term “vehicle” may include, but is not limited to: cars, trucks, vans, minivans, SUVs, motorcycles, scooters, boats, personal watercrafts, or aircrafts. In some cases, a motor vehicle includes one or more engines. Further, the term “vehicle” can refer to an electric vehicle (EV) that is capable of carrying one or more users and is powered entirely or partially by one or more electric motors powered by an electric battery. The EV can include battery electric vehicles (BEV) and plug-in hybrid electric vehicles (PHEV). The term “vehicle” can also refer to an autonomous vehicle and/or self-driving vehicle powered by any form of energy. The autonomous vehicle can carry one or more users. Further, the term “vehicle” can include vehicles that are automated or non-automated with pre-determined paths or free-moving vehicles.

The term “vehicle system,” as used herein, may refer to an electronically controlled system on a vehicle operable to perform certain actions on components of the vehicle, which may provide an interface to allow operation by another system or graphical user interaction. The vehicle system may include, but are not limited to, vehicle ignition systems, vehicle conditioning systems (e.g., systems that operate a windshield wiper motor, a windshield washer fluid motor or pump, a defroster motor, heating, ventilating, or air conditioning (HVAC) controls), vehicle audio systems, vehicle security systems, vehicle video systems, vehicle infotainment systems, vehicle telephone systems, and/or the like.

The term “vehicle applications” or “applications,” as used herein, may refer to any software run by the vehicle system, which may provide information or data to a user of the vehicle, or may receive information or data from a user of a vehicle. The vehicle applications may be displayed on the screen and may include, but are not limited to, navigation, radio, telephone, settings, electric charging, status information, cameras, web browsers, e-mail, games, utilities, and/or the like.

The term “graphical user interface,” “GUI,” or “user interface,” as used herein, may refer to a type of interface that allows users to interact with electronic devices, the vehicle system, the vehicle, vehicle applications or the like, through graphical icons, visual indicators such as secondary notation, text-based, type command labels, text navigation, and/or the Ike,

The term “screen,” “display screen,” or “display,” as used herein, may refer to a surface area upon which text, graphics and video are temporarily made to appear for human viewing. These may include, but are not limited to, eidophor, electroluminescent display (“ELD”), electronic paper, e-Ink, gyricon, light emitting diode display (“LED”), cathode ray tube (“CRT”), liquid-crystal display (“LCD”), plasma display panel (“PDP”), digital light processing (“DLP”), and/or the like.

The term “communications device,” as used herein, may refer to a device that facilitates intercommunication among vehicle systems, communication with the vehicle systems via one or more other systems or devices, etc. In an example, communication device may interface with other systems, such as a remote device (e.g., mobile device), other computers, etc., via a wireless communication technology, such as a cellular technology, Bluetooth, etc. using a corresponding modem or transceiver.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of certain systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

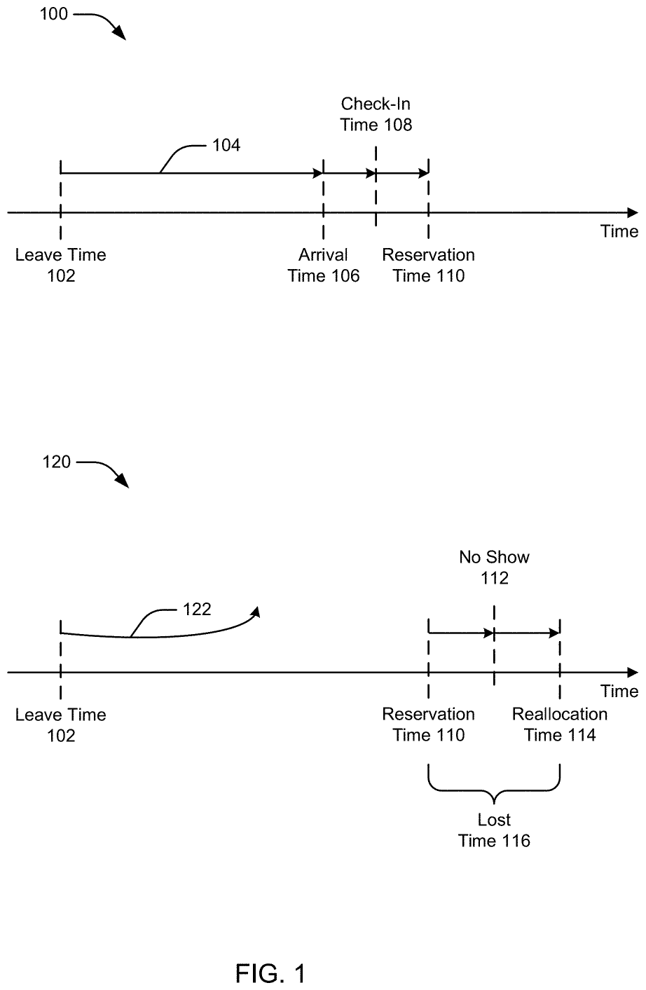

Referring to FIG. 1, examples of representative views of interactions between a user and a service provider are illustrated. In a first example 100, a user may have scheduled an appointment at a service provider's location at a reservation time 110. Examples of the appointment may include a doctor/dental appointment or a restaurant reservation, or any other type of appointment requiring a reservation prior to arrival at the service provider's location. The user may leave from an initial location, such as the user's home or some other location, at a leave time 102 to travel via a travel route between the user's initial location and the service provider's location such that the user arrives by the reservation time 110. The user may travel to the service provider's location by way of any suitable transportation mode including, but not limited to, a personal vehicle, public transportation, and/or commercial transportation. A travel route may require a travel time 104 of X amount of time to travel. The user may arrive at the service provider's location at an arrival time 106 and then be required check in by check-in time 108 prior to the reservation time 110. During check in, the user may provide information such as an identity of the user, a check-in time of the user, purpose for the reservation, and/or verification of personal information, including address or insurance of the user. Once the check in is complete, the user may wait until the reservation time 110, if needed. At the reservation time 110, the service provider may provide a service for the user, such as perform a medical check-up or perform a consultation with the user.

In a second example 120, a user may have scheduled an appointment at a service provider's location at the reservation time 110. However, in this example, the user may not arrive at the service provider's location for the appointment. For example, the user may not leave the initial location to travel to the service provider's location, or the user may leave the initial location at a leave time 102 but may not arrive at a service provider's location. As shown by example 120, the user may thus have a failed travel time 122. In this example, the service provider may wait until the reservation time 110, then may wait until a no show time 112 (e.g., 15 minutes after reservation time 110) to determine that the user will not arrive, and then may attempt to reallocate the appointment for a second user. The service provider may reallocate the appointment time to the second user by a reallocation time 114. Reallocation of the appointment time may be carried out through contacting new users (e.g., other patients, customers, clients) or by rearranging current other user schedules. In determining that the user was a no show, a significant amount of wasted or lost time 116 may occur for the service provider. For example, in some situations, such as large service providers including hospitals, numerous no shows may cause a significant amount of lost time 116 over a period of a week or month, for example. The present disclosure provides a mobility service that may prevent the lost time 116 and allow service providers efficient methods to mitigate no shows.

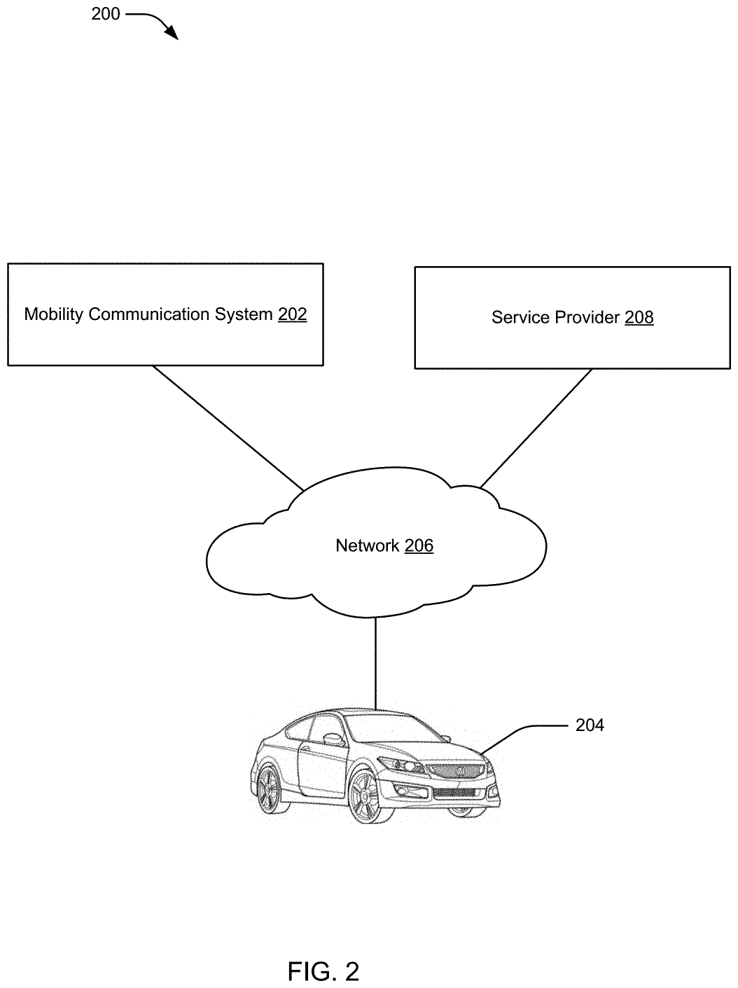

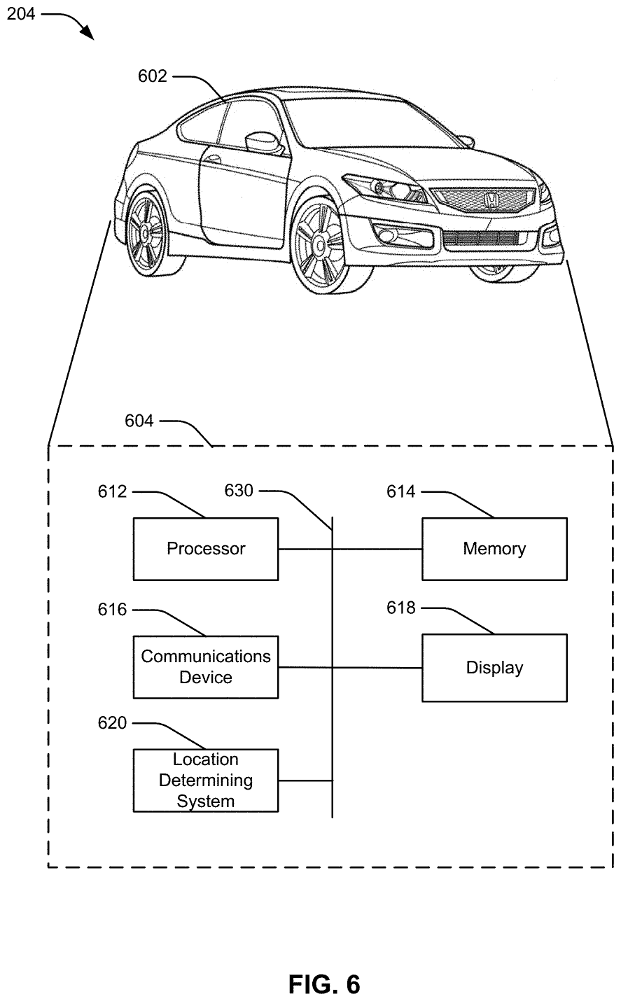

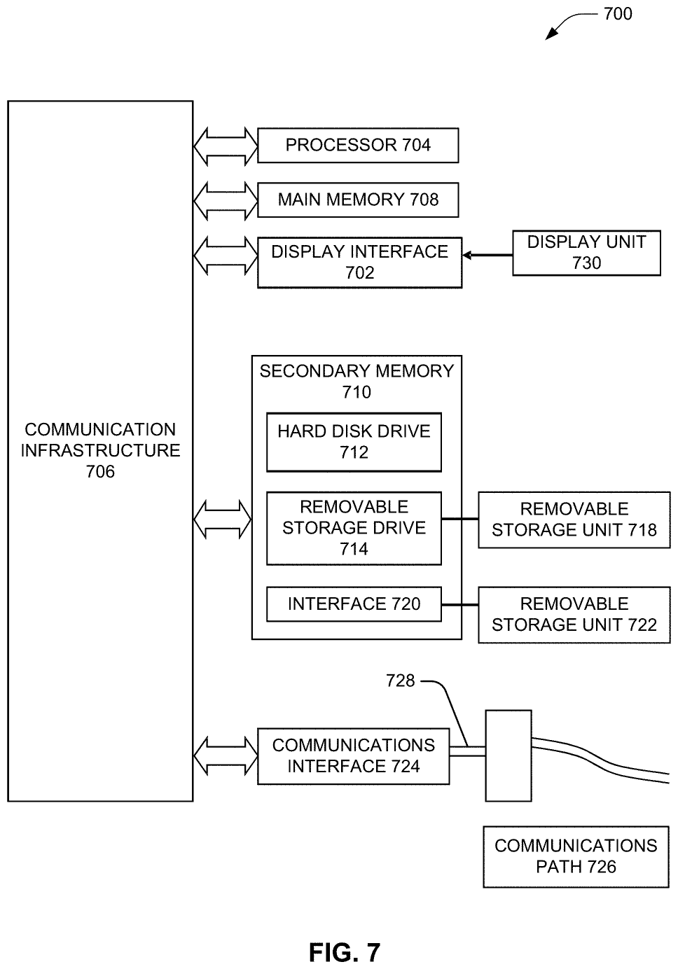

Referring to FIG. 2, a representative view of a mobility system 200 for providing a mobility service, according to one aspect of the disclosure, is illustrated. As shown, in an aspect, the mobility system 200 may include a mobility communication system 202 that is communicatively coupled with a mobility vehicle 204, for example, and a service provider 208 (also interchangeably referred to herein as the service provider's location 208) via a network 206, such as the Internet or an intranet. Connections between the mobility communication system 202 and the mobility vehicle 204 may be wireless. Connections between the mobility communication system 202 and the service provider 208 may be wired, wireless, or fiberoptics. The mobility communication system 202 may include a communications device or system configured to provide communications from the mobility vehicle 204 to the service provider 208 and vice versa. As shown, the mobility communication system 202 may be remote from the service provider 208. However, in some examples, the mobility communication system 202 may be located at a service provider's location 208. Examples of the mobility communication system 202 may include a PC, minicomputer, mainframe computer, microcomputer, or other device having a processor and a repository for data and/or connection to a repository for data (see e.g., the computer system 700 of FIG. 7). The mobility vehicle 204 may include a mode of transportation, such as a vehicle with a driver to transport a user to the service provider's location. The mobility vehicle 204 may include a communication device or system (see e.g., FIG. 6) for communicating with the mobility communication system 202.

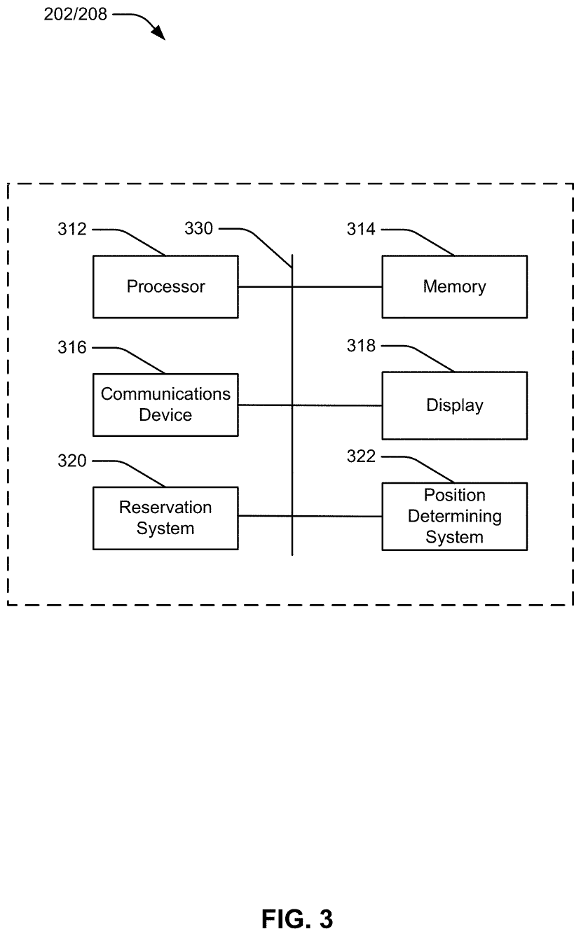

While FIG. 2 illustrates only a single service provider 208 and a single mobility vehicle 204, it will be apparent to those skilled in the art that the concepts of mobility service, as described herein, may apply to a plurality of service providers and a plurality of mobility vehicles functioning within a mobility service and communicating with the mobility communication system 202. Further implementations of the mobility service 200 for providing the mobility service are described below in reference to FIGS. 3-5.

Referring to FIG. 3, an example of a representative schematic view of the mobility communication system 202 or the service provider 208 of the mobility system 200 according to aspects described herein is illustrated. Components of the mobility communication system 202 or the service provider 208, as well as the components of other systems, hardware architectures and software architectures discussed herein, may be combined, omitted or organized into different architectures for various aspects of the disclosure. However, the example aspects and configurations discussed herein focus on the mobility service described herein, with corresponding system components and related methods.

As shown in FIG. 3, the mobility communication system 202 or the service provider 208 may include or be operably coupled with (or executed by) one or more processors 312 and memory 314 that communicate to effectuate certain functions or actions, as described herein. The one or more processors 312 may be configured to execute instructions or code stored on the memory 314. In an example implementation, the instructions or code may include instructions or code for providing mobility services such as those described herein.

The mobility communication system 202 or the service provider 208 may additionally include or be operably coupled with a communications device 316, which may include substantially any suitable wired or wireless device, or related modem, etc., for providing wired or wireless communications utilizing various protocols to send/receive electronic signals internally to features and systems within the mobility communication system 202 or within the service provider 208 and/or to external devices including the mobility communication system 202 (i.e., electronic signals from the service provider 208), the mobility vehicle 204, or the service provider 208 (i.e., electronic signals from the mobility communication system 202). In an example, the communications device 316 may communicate using one or more radio access technologies (e.g., 3GPP radio access technologies, IEEE 802.11, Bluetooth®).

The mobility communication system 202 or the service provider 208 may additionally include or be operably coupled with a reservation system 320 for managing reservations for a plurality of users. For example, the reservation system 320 may determine a reservation time for a user, may update a reservation time, and/or reallocate a reservation time according to communications within a mobility service as described herein.

The mobility communication system 202 or the service provider 208 may additionally include or be operably coupled with a position determining system 322 for tracking a position of the mobility vehicle 204. In an example, the position determining system 322 may receive location information from the mobility vehicle 204. The location information may include an address, coordinates, or any other information for determining the position of the mobility vehicle 204. In some examples, the position determining system 322 may be a subcomponent of the communication device 316.

Additionally, the mobility communication system 202 or within the service provider 208 may include or be operably coupled with a display 318 (interchangeably referred to herein as a screen) for displaying location information (e.g., location, position, destination, route, estimated time of arrival) of the mobility vehicle 204, reservation information (see e.g., reservation time 110 (FIG. 3), reallocation time 414 (FIG. 3), check-in information), and/or any other information or applications related to one or more mobility services. In some examples, the display 318 may include a liquid crystal display (LCD) and/or variants thereof, plasma display, etc., and/or may be part of a touchscreen display. In some examples, the display 318 may be configured to accept inputs from a user regarding selections or preferences of the user via a graphical user interface (GUI).

In some examples, the various components of the mobility communication system 202 or the service provider 208 may be operably coupled to one another via one or more busses 330 to facilitate communication among the components to perform functions described herein. Moreover, one or more of the components described for the mobility communication system 202 or the service provider 208 may be part of another system. For example, one or more of the processors 312, the memory 314, the communications device 316, the reservation system 320, or the display 318 may be part of one or more of other systems within the mobility system 200.

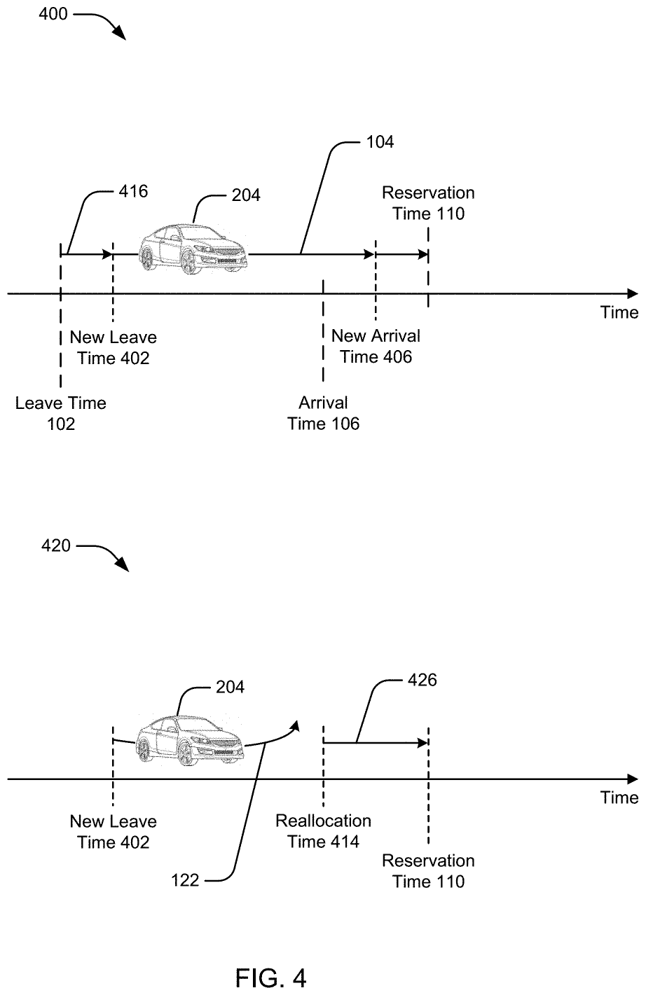

Referring to FIG. 4, examples 400, 420 of mobility services are illustrated in representative form. In a third example 400, a user may have scheduled an appointment at a service provider's location 208 (FIG. 2) at a reservation time 110. In this example, the service provider 208 may provide the mobility vehicle 204 to the user for transportation to the service provider's location 208. The mobility vehicle 204 may travel via a travel route between the user's initial location and the service provider's location 208 such that the user arrives by the reservation time 110. While traveling, the mobility vehicle 204 may transmit to the service provider 208 an indication that the user is being transported to the service provider's location 208. In some examples, the indication may include an estimated time of arrival for the mobility vehicle 204 to arrive at the service provider's location 208. Further, the user, while traveling by the mobility vehicle 204, may provide check-in information, and the indication to the service provider 208 may include the check-in information. Check-in information may include but is not limited to a user profile and user preferences, such as an identity of the user, a check-in time of the user, purpose for the reservation, and/or verification of personal information, including address or contact numbers of the user. For example, the check-in information may include hospital patient number and insurance information, etc., for a doctor or hospital service provider; seat location and food preferences, etc., for a restaurant or movie service provider; or information, such as non-smoking, AC temperature, and perfume preferences, for the next mobility servicer provider (e.g., when arriving at the airport then switching to a taxi or ride-hailing service).

In the third example 400, the user may leave the initial location at a new leave time 302 and arrive via the mobility vehicle 204 at the service provider's location 208 at a new arrival time 406. In comparison with the first example 100, the travel time 104 may be the same; however, the new leave time 402 may be after the leave time 102, and the new arrival time 406 may be after the arrival time 106. The shifted times of the new leave time 402 and the new arrival time 406 may include the user providing check-in information while traveling via the mobility vehicle 204. As such, while the new arrival time 406 may be closer in time to the reservation time 110, the completed check-in may result in less time for the user to wait at the service provider's location 208 prior to the reservation time 110.

In the third example 400, the user may benefit from using the mobility service with gained time 416 which may include the time difference between the leave time 102 and the new leave time 402. In some examples, the gained time 416 may include additional amounts of time that the user may gain due to the lack of the user needing to park at the service provider's location 208, no wait time for the user to check in at the service provider's location 208, and/or any other beneficial time received through the user of the mobility service.

In a fourth example 420, the service provider 208 may provide the mobility vehicle 204 for the user to arrive at the appointment at a service provider's location 208 by the reservation time 110. However, in this example, the user may not arrive at the service provider's location 208 for the appointment. For example, the user may not leave the initial location to travel to the service provider's location 208, or the mobility vehicle 204 may leave the initial location with the user at the new leave time 402 but may not arrive at a service provider's location 208. As shown by example 420, the user may thus have a failed travel time 122. In this example, the mobility vehicle 204 may provide an indication to the service provider 208 well prior to the reservation time 110 that the user will not arrive at the service provider's location 208 by the reservation time 110. In receiving the indication of the no show, the service provider 208 may reallocate the appointment time at a reallocation time 414.

As shown by the fourth example 420, the reallocation time 414 may be a significant amount of time before the reservation time 110. Accordingly, the service provider 208 may benefit from the mobility vehicle 204 by a gained time 426, which may include a significant portion of the time between the new leave time 402 and the reservation time 110.

In comparison with the first and second examples 100, 120, the third and fourth examples 400, 420 may provide a user and service provider 208 participating in the mobility service substantial time benefits including the gained times 416, 426, as previously discussed. Further, incorporation of the mobility service may also allow the service provider 208 the reliability of receiving the indication of a no show without depending on the user to provide this information. The mobility service may also increase the number of users that a service provider 208 is able to schedule during any day due to a consistent flow of users checking in and checking out from the service provider's location 208 according to designated reservations times (e.g., reservation time 110).

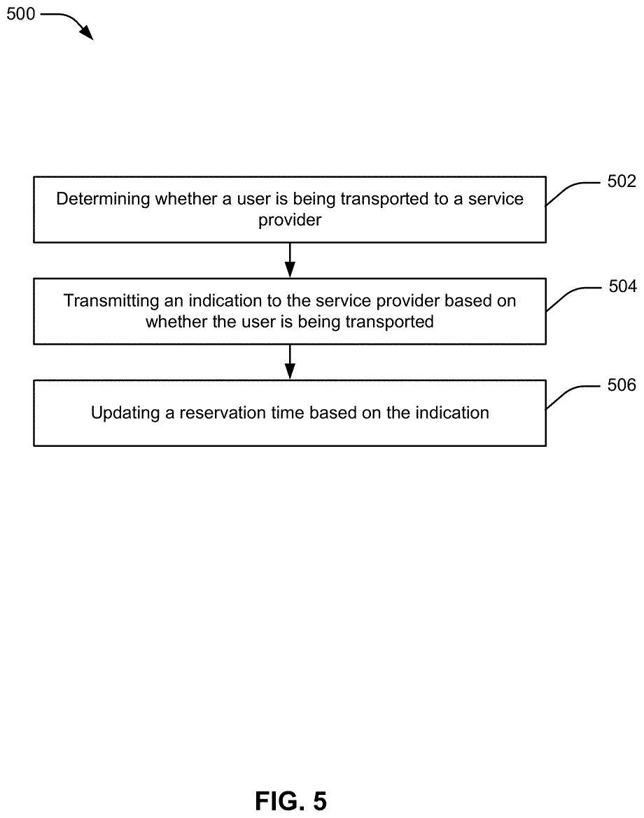

Referring to a FIG. 5, a flowchart of an example method 500 for providing mobility service according to one aspect of the disclosure is illustrated. Aspects of the method 500 may be performed by one or more components, or subcomponents, of the mobility communication system 202, the mobility vehicle 204, and/or the service provider 208. Details of the components, and the subcomponents, of the mobility communication system 202, the mobility vehicle 204, and/or the service provider 208 are provided in reference to FIGS. 2-3 and 6-7.

At block 502, the method 500 may include determining whether a user is being transported to a service provider. In an aspect, one or more components or subcomponents (e.g., processor 312, communications device 316, reservation system 320, or position determining system 322 of FIG. 3) of the mobility communication system 202 may determine whether a user is being transported to the service provider 208. For example, as shown in FIGS. 2-4, the mobility communication system 202 may receive an indication from the mobility vehicle 204 whether the user is in the mobility vehicle 204. In some examples, the indication may be an explicit indication such as a message from the mobility vehicle 204 to the mobility communication system 202. In some examples, the indication may be an implicit indication—such as communication or the lack of communication between the mobility vehicle 204 and the mobility communication system 202—indicating whether the user is in the mobility vehicle 204 or not. In some examples, the indication may also include check-in information corresponding to the user and/or an estimated time of arrival of the user at the service provider's location 208.

In some examples, the method 500 may also include determining, prior to the reservation time, that the user is not being transported to the service provider. For example, one or more components or subcomponents (e.g., processor 312, communications device 316, reservation system 320, or position determining system 322 of FIG. 3) of the mobility communication system 202 may determine, prior to the reservation time, the user is not being transported to the service provider's location 208. As shown, for example, in FIGS. 2-4, the determination that the user is not being transported may be based on the mobility communication system 202 receiving an indication from the mobility vehicle 204 that the user has not entered the mobility vehicle 204 or for some reason the mobility vehicle 204 will not arrive at the service provider's location 208 by the reservation time 110.

In some examples, the method 500 may also include determining, prior to the reservation time, that the user is being transported to the service provider. For example, one or more components or subcomponents (e.g., processor 312, communications device 316, reservation system 320, or position determining system 322 of FIG. 3) of the mobility communication system 202 may determine, prior to the reservation time, the user is being transported to the service provider's location 208. As shown, for example, in FIGS. 2-4, the determination that the user is being transported may be based on the mobility communication system 202 receiving an indication from the mobility vehicle 204 that the user has entered the mobility vehicle 204 and/or an indication that the mobility vehicle 204 will arrive at the service provider's location 208 by the reservation time 110.

At block 504, the method 500 may include transmitting an indication to the service provider based on whether the user is being transported. In an aspect, one or more components or subcomponents (e.g., processor 312, communications device 316, reservation system 320, or position determining system 322 of FIG. 3) of the mobility communication system 202 may transmit an indication to the service provider 208 based on whether the user is being transported.

At block 506, the method 500 may include updating a reservation time based on the indication. In an aspect, a component (e.g., processor 312, communications device 316, or reservation system 320 of FIG. 3) of the mobility communication system 202 may update a reservation time based on the indication. For example, as shown in FIGS. 2-4, the mobility communication system 202 may update the reservation time of the user to indicate that the user is checked in or may update the reservation time to indicate that the user is a no show. In the case that the user is going to be a no show (i.e., the user will not arrive by the reservation time 110) updating the reservation time may include reallocating the reservation time for a second user. For example, in an aspect, a component (e.g., processor 312, communications device 316, or reservation system 320 of FIG. 3) of the mobility communication system 202 may rearrange a current schedule to allow another user to have an earlier appointment at the reservation time 110 or another user may be contacted to schedule an appointment during the reservation time 110.

Referring to FIG. 6, an example of a representative schematic view of various components and/or features of the mobility vehicle 204 according to aspects described herein, is illustrated. The mobility vehicle 204 may include a structure 602 of the mobility vehicle 204, within which as a housing a mobility vehicle communication system 604 may at least partially reside and/or be implemented. Components of the mobility vehicle communication system 604, as well as the components of other systems, hardware architectures and software architectures discussed herein, may be combined, omitted or organized into different architectures for various aspects of the disclosure. However, the example aspects and configurations discussed herein focus on the mobility service described herein, with corresponding system components and related methods.

The mobility vehicle communication system 604 may include or be operably coupled with (or executed by) one or more processors 612 and memory 614 that communicate to effectuate certain functions or actions, as described herein. The one or more processors 612 may be configured to execute instructions or code stored on the memory 614. In an implementation, the instructions or code may include instructions or code for providing mobility services, as described herein.

The mobility vehicle communication system 604 may additionally include or be operably coupled with a communications device 616, which may include substantially any wired or suitable wireless device, or related modem, etc., for providing wired or wireless communications utilizing various protocols to send/receive electronic signals internally to features and systems within the mobility vehicle 204 and/or to external devices including the mobility communication system 202. In an example, the communications device 616 may communicate using one or more radio access technologies (e.g., 3GPP radio access technologies, IEEE 802.11, Bluetooth®).

The mobility vehicle communication system 604 may additionally include or be operably coupled with a location determining system 620 for determining a location/position of the mobility vehicle 204. For example, the location determining system 620 may determine one or more location-related parameters, such as location, position, speed, acceleration, and direction, nearby images, among other parameters, relating to the mobility vehicle 204. In some examples, the location determining system 620 may include or may be operably coupled with a global positioning system (“GPS”) device (or other latitude/longitude determination device), a speedometer, an accelerometer, a gyroscope, and/or the like, to determine the location-related parameters.

Additionally, the mobility vehicle communication system 604 may include or be operably coupled with a display 618 (interchangeably referred to herein as a screen) for displaying location information (e.g., location, position, destination, route, estimated time of arrival), vehicle information (e.g., tachometer, speedometer, fuel gauge, heating/cooling), infotainment information (e.g., radio, media files, navigation system), and/or any other information or applications related to one or more vehicle systems. In some examples, the display 618 may include a liquid crystal display (LCD) and/or variants thereof, plasma display, etc., and/or may be part of a touchscreen display. In some examples, the display 618 may be configured to accept inputs from a user regarding selections or preferences of the user via a graphical user interface (GUI).

In some examples, the various components of the mobility vehicle communication system 604 may be operably coupled to one another via one or more busses 630 to facilitate communication among the components to perform functions described herein. Moreover, one or more of the components described for the mobility vehicle communication system 604 may be part of another system. For example, one or more of the processors 612, the memory 614, the communications device 616, the location determining system 620, or the display 618 may be part of one or more of an infotainment system, a navigation system, or safety system of the mobility vehicle 204.

Referring to FIG. 7, an example system is presented with a diagram of various hardware components and other features, for use in accordance with an aspect of the present disclosure. Aspects of the present disclosure may be implemented using hardware, software, or a combination thereof and may be implemented in one or more computer systems or other processing systems. In one example variation, aspects described herein may be directed toward one or more computer systems capable of carrying out the functionality described herein. An example of such a computer system 700 is shown in FIG. 7.

The computer system 700 may be a computer system used by the mobility communication system 202, the mobility vehicle 204, and/or the service provider 208. The computer system 700 may include one or more processors, such as processor 704. The processor 704 is connected to a communication infrastructure 706 (e.g., a communications bus, cross-over bar, or network). In an example, the processor 704 may be an example of the processor 512 or the processor 612, as described herein. Various software aspects are described in terms of this example computer system 700. After reading this description, it will become apparent to a person skilled in the relevant art(s) how to implement aspects described herein using other computer systems and/or architectures.

The computer system 700 may include a display interface 702 that forwards graphics, text, and other data from the communication infrastructure 706 (or from a frame buffer not shown) for display on a display unit 730. The display unit 730 may be an example of the display 518 or the display 618. The computer system 700 may also include a main memory 708, e.g., random access memory (RAM), and may also include a secondary memory 710. The secondary memory 710 may include, e.g., a hard disk drive 712 and/or a removable storage drive 714, representing a floppy disk drive, a magnetic tape drive, an optical disk drive, etc. The removable storage drive 714 may read from and/or write to a removable storage unit 718 in a well-known manner. The removable storage unit 718, represents a floppy disk, magnetic tape, optical disk, etc., which is read by and written to the removable storage drive 714. As will be appreciated, the removable storage unit 718 may include a computer usable storage medium having stored therein computer software and/or data.

In alternative aspects, the secondary memory 710 may include other similar devices for allowing computer programs or other instructions to be loaded into the computer system 700. Such devices may include, e.g., a removable storage unit 722 and an interface 720. Examples of such may include a program cartridge and cartridge interface (such as that found in video game devices), a removable memory chip (such as an erasable programmable read only memory (EPROM), or programmable read only memory (PROM)) and associated socket, and other removable storage units 722 and interfaces 720, which allow software and data to be transferred from the removable storage unit 722 to the computer system 700. The memory 514 or the memory 614 may include one or more of the main memory 708, the secondary memory 710, the removable storage drive 714, the removable storage unit 718, or the removable storage unit 722.

The computer system 700 may also include a communications interface 724. The communications interface 724 may allow software and data to be transferred between the computer system 700 and external devices. Examples of the communications interface 724 may include a modem, a network interface (such as an Ethernet card), a communications port, a Personal Computer Memory Card International Association (PCMCIA) slot and card, etc. Software and data transferred via communications interface 724 are in the form of signals 728, which may be electronic, electromagnetic, optical or other signals capable of being received by the communications interface 724. These signals 728 are provided to the communications interface 724 via a communications path (e.g., channel) 726. This path 726 carries signals 728 and may be implemented using wire or cable, fiber optics, a telephone line, a cellular link, a radio frequency (RF) link and/or other communications channels. The terms “computer program medium” and “computer usable medium” are used to refer generally to media such as a removable storage drive, a hard disk installed in a hard disk drive, and/or signals 728. These computer program products provide software to the computer system 700. Aspects described herein may be directed to such computer program products. In an example, the communications device 516 or the communications device 616 may include the communications interface 724.

Computer programs (also referred to as computer control logic) may be stored in the main memory 708 and/or the secondary memory 710. The computer programs may also be received via the communications interface 724. Such computer programs, when executed, enable the computer system 700 to perform various features in accordance with aspects described herein. In particular, the computer programs, when executed, enable the processor 704 to perform such features. Accordingly, such computer programs represent controllers of the computer system 700. The computer programs may include instructions or code for executing methods of the mobility service as described herein.

In variations where aspects described herein are implemented using software, the software may be stored in a computer program product and loaded into the computer system 700 using the removable storage drive 714, the hard disk drive 712, or the communications interface 720. The control logic (software), when executed by the processor 704, causes the processor 704 to perform the functions in accordance with aspects described herein. In another variation, aspects are implemented primarily in hardware using, e.g., hardware components, such as application specific integrated circuits (ASICs). Implementation of the hardware state machine so as to perform the functions described herein will be apparent to persons skilled in the relevant art(s). In yet another example variation, aspects described herein are implemented using a combination of both hardware and software.

The aspects discussed herein may also be described and implemented in the context of computer-readable storage medium storing computer-executable instructions. Computer-readable storage media includes computer storage media and communication media, and may be, flash memory drives, digital versatile discs (DVDs), compact discs (CDs), floppy disks, and tape cassettes. Computer-readable storage media may include volatile and nonvolatile, removable and non-removable media implemented in any method or technology for storage of information such as computer readable instructions, data structures, modules or other data.

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A system, comprising:
a memory storing instructions;
one or more processors communicatively coupled with the memory, a communication device of a mobility vehicle, and a communication device of a service provider, the one or more processors being configured to execute the instructions to:
determine whether a user is being transported to the service provider based on information from the communication device of the mobility vehicle;
transmit an indication to the service provider via the communication device of the service provider based on whether the user is being transported; and
update a reservation time corresponding to an appointment for the user with the service provider based on the indication.

2. The system of claim 1, wherein the one or more processors is further configured to:
determine, prior to the reservation time, the user is not being transported to the service provider; and
reallocate the reservation time for a second user.

3. The system of claim 1, wherein the one or more processors is further configured to:
determine, prior to the reservation time, the user is being transported to the service provider, wherein the indication includes check-in information corresponding to the user.

4. The system of claim 1, wherein the one or more processors is further configured to:
determine, prior to the reservation time, the user is being transported to the service provider, wherein the indication includes an estimated time of arrival of the user at the service provider.

5. The system of claim 1, wherein the one or more processors is further configured to:
receive a message from the communication device of the mobility vehicle; and
determine whether the user is being transported to the service provider based on the message.

6. A method for mobility services, comprising:
determining, by a one or more processors, whether a user is being transported to a service provider based on information from a communication device of a mobility vehicle communicatively coupled with the one or more processors;
transmitting, by the processor, an indication to the service provider, via a communication device of the service provider communicatively coupled with the one or more processors, based on whether the user is being transported; and
updating, by the processor, a reservation time corresponding to an appointment for the user with the service provider based on the indication.

7. The method of claim 6, further comprising:
determining, prior to the reservation time, the user is not being transported to the service provider; and
reallocating the reservation time for a second user.

8. The method of claim 6, further comprising:
determining, prior to the reservation time, the user is being transported to the service provider, wherein the indication includes check-in information corresponding to the user.

9. The method of claim 6, further comprising:
determining, prior to the reservation time, the user is being transported to the service provider, wherein the indication includes an estimated time of arrival of the user at the service provider.

10. The method of claim 6, further comprising:
receiving a message from the communication device of the mobility vehicle; and
determining whether the user is being transported to the service provider based on the message.

11. A computer-readable medium storing executable code for providing mobility services, the code being executable on one or more processors, comprising code to:
determine whether a user is being transported to a service provider based on information from a communication device of a mobility vehicle communicatively coupled with the one or more processors;
transmit an indication to the service provider, via a communication device of the service provider communicatively coupled with the one or more processors, based on whether the user is being transported; and
update a reservation time corresponding to an appointment for the user with the service provider based on the indication.

12. The computer-readable medium of claim 11, further comprising code to:
determine, prior to the reservation time, the user is not being transported to the service provider; and
reallocate the reservation time for a second user.

13. The computer-readable medium of claim 11, further comprising code to:
determine, prior to the reservation time, the user is being transported to the service provider, wherein the indication includes check-in information corresponding to the user.

14. The computer-readable medium of claim 11, further comprising code to:
determine, prior to the reservation time, the user is being transported to the service provider, wherein the indication includes an estimated time of arrival of the user at the service provider.

15. The computer-readable medium of claim 11, further comprising code to:
receive a message from the communication device of the mobility vehicle; and
determine whether the user is being transported to the service provider based on the message.

16. An apparatus, comprising:
means for determining whether a user is being transported to a service provider based on information from a communication device of a mobility vehicle;
means for transmitting an indication to the service provider, via a communication device of the service provider, based on whether the user is being transported; and
means for updating a reservation time corresponding to an appointment for the user with the service provider based on the indication.

17. The apparatus of claim 16, further comprising:
means for determining, prior to the reservation time, the user is not being transported to the service provider; and
means for reallocating the reservation time for a second user.

18. The apparatus of claim 16, further comprising:
means for determining, prior to the reservation time, the user is being transported to the service provider, wherein the indication includes check-in information corresponding to the user.

19. The apparatus of claim 16, further comprising:
means for determining, prior to the reservation time, the user is being transported to the service provider, wherein the indication includes an estimated time of arrival of the user at the service provider.

20. The apparatus of claim 16, further comprising:
means for receiving a message from the communication device of the mobility vehicle; and
means for determining whether the user is being transported to the service provider based on the message.
